(19) United States
(12) Patent Application Publication
(10) Pub. No.: US 2022/0015527 A1
(43) Pub. Date: Jan. 20, 2022

(54) WAIST BAG WITH ATTACHED BOTTLE CAP OPENER

(71) Applicant: David Mesqueue, Toa Alta, PR (US)

(72) Inventor: David Mesqueue, Toa Alta, PR (US)

(21) Appl. No.: 17/305,763

(22) Filed: Jul. 14, 2021

Related U.S. Application Data
(60) Provisional application No. 62/705,749, filed on Jul. 14, 2020.

(51) Int. Cl. A45F 3/00; B67B 7/16

(52) U.S. Cl. CPC A45F 3/005; A45F 2003/003; B67B 7/16

(57) ABSTRACT

A bag with an integral bottle cap opener includes a body, multiple straps, a pair of buckle components, and a strap size adjuster. A first strap having the first buckle component extends from a first edge of the body and a second strap extends from a second edge of the body. A third strap connected to the second strap has the second buckle component at the opposite end and has the strap size adjuster therebetween. The bottle cap opener has a first slot adjacent to a first side and a second slot adjacent to an opposite side with an aperture therebetween. A border protrudes into the aperture. The first slot is joined to the first strap, the second strap, or the third strap. The bottle cap opener is effective to grasp a bottle cap. The first buckle component is couplable to the second buckle component.

### CROSS-REFERENCE TO RELATED APPLICATION

This application claims the benefit of priority of U.S. provisional application No. 62/705,749, filed Jul. 14, 2020, the contents of which are herein incorporated by reference.

### BACKGROUND OF THE INVENTION

The present invention relates to a waist bag and, more particularly, to a bag with a bottle cap opener integrally attached.

Finding a bottle cap opener at the right moment is a challenge. A person needs to remember to carry a bottle cap opener inside his or her bag, such as a waist bag. However, the user must open the waist bag to find the opener. Moreover, bottle cap openers carried inside a waist bag are easily left behind once taken out of the bag.

As can be seen, there is a need for a bottle cap opener that will not be lost or left behind and is readily accessible.

### SUMMARY OF THE INVENTION

The present invention provides a waist bag with a bottle cap opener attached to the strap belt. The inventive waist bag may be worn around the waist. The bottle cap opener may be used to open a bottle cap with a simple twist regardless of whether the waist bag is removed from the waist. The invention eliminates the need to open the bag to retrieve a bottle cap opener. The waist bag with integral bottle cap opener is especially advantageous for bartenders and waitresses in the food and beverage industry, as they need to handle cash and change and to open bottles.

In one aspect of the present invention, a bag with an integral bottle cap opener is provided, comprising: a body with a first strap extending from a first edge of the body and a second strap extending from a second edge of the body, said first strap having a first buckle component at an end opposite the body; a third strap connected to said second strap, said third strap having a second buckle component at an end opposite the second strap and having a strap size adjuster therebetween; and a bottle cap opener having a first slot adjacent to a first side, a second slot adjacent to a second side opposite the first side, and an aperture therebetween, a border of which protrudes into the aperture; the first slot of said bottle cap opener being joined to the first strap, the second strap, or the third strap. The bottle cap opener is effective to grasp a bottle cap and the first buckle component is couplable to the second buckle component.

These and other features, aspects and advantages of the present invention will become better understood with reference to the following drawings, description, and claims.

### BRIEF DESCRIPTION OF THE DRAWINGS

FIG. 1 is a perspective view of a waist bag according to an embodiment of the present invention;

FIG. 2 is a detail front elevation view of a bottle cap opener thereof; and

FIG. 3 is a detail perspective view thereof, shown in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a bag with an integrated bottle opener. The inventive bag generally comprises a fabric bag, fabric straps, a bottle cap opener, buckles, and a fabric strap size adjuster. The bottle cap opener serves to join the straps of the waist bag, making the bottle cap opener an integral and functional part of the strap, while being handy and seamless.

The bottle cap opener may have a generally rectangular or square shape with slotted openings or inserts at opposing ends into which the fabric bag straps may be threaded. The central portion of the bottle cap opener may have a central or off-centered opening bordered with a protruding edge such that the opening is effective to grasp a bottle cap for removal from the bottle. Once the straps are threaded through the bottle cap opener slots, the waist straps may be folded over and sewn to securely hold the bottle cap opener.

The bottle cap opener may be sewn or attached in any part of the fabric strap, the buckle, the fabric strap adjuster, or the bag; the components may be alternated and assembled in any suitable order if the bottle cap opener is attached to at least one strap portion.

The fabric bag may be any suitable type of bag, including for example, a crossbody bag, a travel bag, a backpack, or any other type of bag in which a bottle cap opener may be inserted in the straps.

The buckle components are not particularly limited. The buckle may comprise a male component and a female component or any other suitable type of buckle.

The length and size of each component is not particularly limited. The materials of manufacture are also not particularly limited. The waist bag and straps generally comprise a sturdy fabric stitched together. The bottle cap opener may made from any suitable metal, for example by use of a mold. The buckles and the fabric strap size adjuster may be molded from any suitable plastic or metal. The buckle and fabric strap size adjuster may be sewn into the straps.

The components are attached by means that are not particularly limited. The components may be sewn, stapled, glued, heat bonded, or otherwise securely connected to each other.

In some embodiments, the waist bag further comprises zippers.

The bag may be used to open bottle caps, whether the user is wearing the bag or the bag is removed. A bottle cap may be removed while wearing the bag by twisting the bottle cap opener from a vertical position (i.e., a portion of the bottle cap opener that protrudes to grasp a bottle cap is positioned vertically) to a horizontal position and inserting the bottle cap, then prying the cap from the bottle in a manner consistent with currently available bottle cap openers. When the user removes the bag, the bottle cap opener may be used in a manner consistent with currently available bottle cap openers to open any bottle cap.

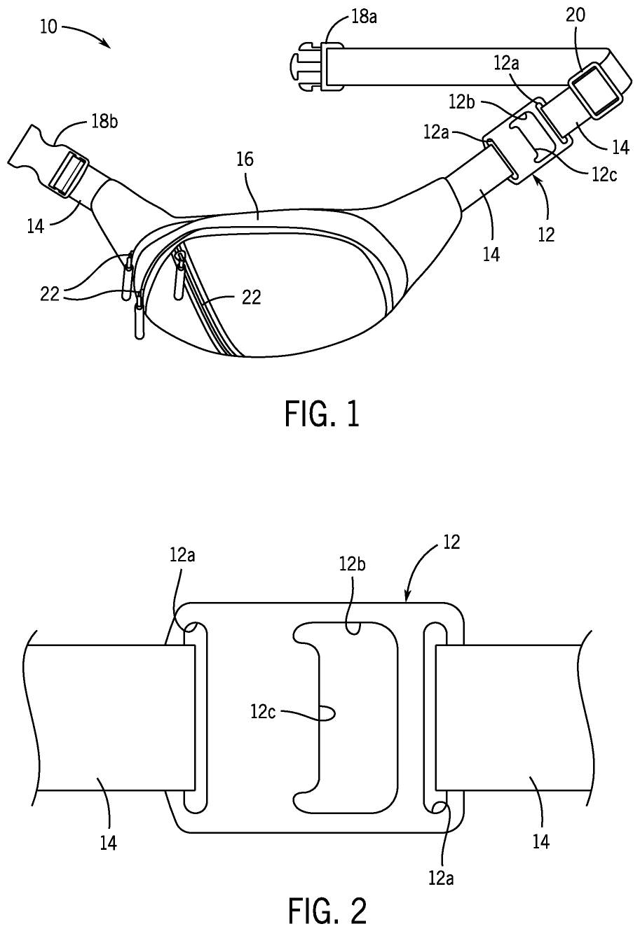

Referring to FIGS. 1 through 3, FIG. 1 shows a waist bag 10 with an integral bottle cap opener 12 according to an embodiment of the present invention. The substantially rectangular bottle cap opener 12 with rounded corners has slotted openings 12a adjacent to each end, a central opening 12b or aperture, and a protruding edge 12c that extends into the central opening 12b. Straps 14 are attached to the bottle cap opener 12 through the slotted openings 12a. The longest strap 14 extends from the bottle cap opener 12 and has a male buckle component 18a attached at the opposite end. The size of the waist bag 10 may be adjusted with a fabric strap size adjuster 20 on the strap 14. The other strap 14 extends from the bottle cap opener 12 and is joined to a fabric body 16 with a plurality of zippers 22. Another strap 14 extending from the opposite end of the fabric body 16 and has a female buckle component 18b attached thereto at the other end. The male buckle component 18a is couplable to the female buckle component 18b.

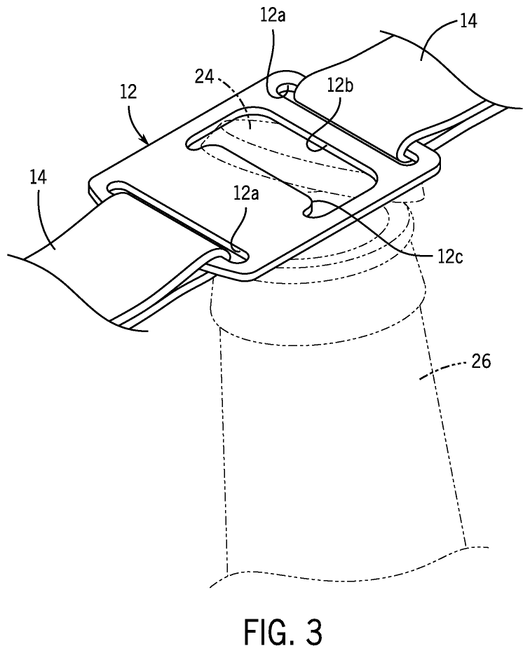

As shown in FIG. 3, the bottle cap opener 12 may be used by wedging the protruding edge 12c of the opener 12 under the bottle cap 24 rim and lifting the cap 24 from the bottle 26 with a twisting motion.

It should be understood, of course, that the foregoing relates to exemplary embodiments of the invention and that modifications may be made without departing from the spirit and scope of the invention as set forth in the following claims.

What is claimed is:

1. A bag with an integral bottle cap opener, comprising:
a body with a first strap extending from a first edge of the body and a second strap extending from a second edge of the body, said first strap having a first buckle component at an end opposite the body;
a third strap connected to said second strap, said third strap having a second buckle component at an end opposite the second strap and having a strap size adjuster therebetween; and
a bottle cap opener having a first slot adjacent to a first side, a second slot adjacent to a second side opposite the first side, and an aperture therebetween, a border of which protrudes into the aperture; the first slot of said bottle cap opener being joined to the first strap, the second strap, or the third strap;
wherein the bottle cap opener is effective to grasp a bottle cap and the first buckle component is couplable to the second buckle component.

2. The bag of claim 1, wherein the body further comprises zippers.

3. The bag of claim 1, wherein the bottle cap opener is substantially rectangular with rounded corners.

4. The bag of claim 1, wherein the aperture is off-center.

5. The bag of claim 1, wherein the second slot is joined to a strap not joined to the first slot selected from the group consisting of the first strap, the second strap, and the third strap.

6. The bag of claim 1, wherein the second slot is joined to the strap size adjuster, the first buckle component, the second buckle component, or the body.
